(19) United States
(12) Patent Application Publication
(10) Pub. No.: US 2002/0046299 A1
(43) Pub. Date: Apr. 18, 2002

(54) Method and system for location independent and platform independent network signaling and action initiating

(75) Inventors: Gideon Lefeber, Haifa (IL); Reuven Goldblat, Kiriat Yam (IL)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Internet2Anywhere, Ltd.

(21) Appl. No.: 09/730,395

(22) Filed: Dec. 6, 2000

Related U.S. Application Data
(60) Provisional application No. 60/181,194, filed on Feb. 9, 2000.

(51) Int. Cl. G06F 9/46; G06F 9/00

(52) U.S. Cl. 709/318; 709/328

(57) ABSTRACT

Disclosed is a system and method for location independent and platform independent network signaling, signal interpreting and action initiating according to the present invention. The invention's method and system provide a mechanism whereby a user can receive time-sensitive notifications regarding an event on an electronic device from a network through various suitable electronic communication mediums and using various signaling mechanisms. The user then initiates, or alternatively the user's device automatically performs, an appropriate action or actions in response to the notification alert. In preferred embodiments of the invention, the network synchronizes, along with the sending of the notification signal to the user, a customized response path for the user to utilize so as to reduce the number of steps and thus simplify the user's input with respect to performing the response actions. Electronic communication mediums suitable for the present invention can be of any infrastructure type including existing types such as standard telephone lines, wireless voice and data networks, and dedicated network wireline communication systems. Signaling mechanisms utilizing such infrastructures comprise various types including online networking protocols and offline protocols.

### RELATED APPLICATIONS

This application claims priority from co-pending and co-owned U.S. provisional applications Ser. No. 60/181,194 filed Feb. 9, 2000, Ser. No. 60/194,047 filed Apr. 3, 2000, Ser. No. 60/214,761 filed Jun. 27, 2000, Ser. No. 60/215,771 filed Jun. 30, 2000, Ser. No. 60/217,725 filed Jul. 12, 2000, Ser. No. 60/225,404 filed Aug. 15, 2000, Ser. No. 60/231,547 filed Sep. 11, 2000, and Ser. No. 60/236,363 filed Sep. 29, 2000.

### FIELD OF INVENTION

The present invention relates to a method and system for providing and receiving an event notification signal over a communication network and initiating follow up action. More particularly, the present invention relates to a location-independent and platform-independent method and system for sending notification signals to registered users over a communication network, and receiving the notification at a remote client device wherein the notification signal instructs the device or registered user to initiate an appropriate response or to perform an action.

### BACKGROUND OF THE INVENTION

Computerized electronic networks that allow users to connect to the network via standard telephone lines, wireless telephone services, or dedicated network lines are known in the art. While online using these network connections, users can perform various functions including obtaining information such as emails or instant messages, and browsing the Internet for news content or electronic commerce opportunities. In the realm of computer networks, at any point in time each client device to the network can be generally defined as either being online or offline. While online, a network user connects the client device to the central network (such as with their PC using a modem and phone line, or with a web-enabled cellular phone) whenever they desire to request information from or transfer information to the network. In the periods wherein the user's client device is not connected, or is offline, the user traditionally could not obtain or transmit any information from the network. Thus, for example, if a subscriber to a dial-up Internet service provider (“ISP”) was awaiting the receipt of an urgent email message in his mailbox on the network, he would either have to stay online with the ISP and have his mail program repeatedly check, or “poll,” the mail server until the server answers a particular poll that the message has finally arrived. Alternatively, he could repeatedly reconnect to the ISP to go online and poll the mail server in an attempt to retrieve the message as soon as possible after its arrival. In both cases, the user would be “pulling” the information of interest off the server in that the availability of the information can only be discovered if an independent action, i.e., polling of the mail server by the user's mail program, is initiated by the user. Similar dilemmas would be faced, for example, by users monitoring stock prices on the Internet, or users awaiting instant message notifications. Because of the need for client devices to remain continuously online to enable polling of mail and other network servers, as well as concerns with data transmission speed limitations and phone line usage, dedicated computer network lines, which enable high speed and continuous online operation, have been becoming more commonplace in the area of traditional wire-line computer networks. The high speed and bandwidth supported by such dedicated lines (such as T1, ISDN, and other like networking connection types) considerably speed up online data transfer. Further, the ability to stay online continuously enables users to track changes in online information in substantially real-time using known polling technologies or using developing “push” technologies (such as is currently being developed for instant messaging) wherein the server automatically sends notifications of or information relating to online events to a client device without requiring initiation by the device.

Traditionally, the ability of a user to be remotely connected to a network was limited to the above-described wire-line based technology. In such cases, the user's client device (such as his or her personal computer) would physically have to be located proximate to an available telephone line (for modem connections) or within a building having, for example, an ISDN line (for dedicated line connections). While these mechanisms allowed users to access computerized networks from various locations, they still required the user to be tied physically to the network via the wire-line connection when online capabilities, such as polling, were desired. In today's highly dynamic business world, however, it has become increasingly important for persons to not only have fast and efficient access to a large variety of time-sensitive information, but also for the exchange and processing of such time-sensitive information to be possible wherever the user is located when the information becomes available.

In order to free network users from the need for wire-line connections when using portable client devices like laptop computers and personal digital assistants or “PDAs,” technologies such as cellular modems and micro-cellular data networks were later developed. Using these technologies, network connections could be made using cellular telephony and other radio frequency (“RF”) network technology such that users could be provided with mobile access to certain types of information on their networks. While these technologies are improving daily and are helping to alleviate the need for wire-line connections, they still have several drawbacks. Specifically with respect to radio frequency data networks, not only is customized bulky and costly hardware often required, but the effective service areas are often limited, and there is not reliable quality of service within those limited service areas. Additionally, even though the cellular modem and RF data network solutions can support online capabilities adapted for wireline environments, such as those based on polling technologies, such capabilities in use are necessarily limited by battery life of the device, bandwidth constraints and airtime charges. Further, these technologies do not allow the above described client devices to provide efficient mobile “on-the-move” capabilities (such as while the user is on a bus or driving) where it is often difficult or impossible for the user to remain online and repeatedly poll network servers to obtain time-sensitive information.

In another attempt to solve the need for improved mobile electronic data transmission, new client devices comprising digital cellular phones having embedded therein software that enables wireless connections to the Internet have been developed. These web-enabled wireless phones communicate with the Internet over cellular telephone voice networks using various wireless communication protocols, the most predominant currently being the wireless access protocol (“WAP”). These protocols essentially scale down the content of the Internet so as to more easily accommodate the low bandwidth constraints imposed by current second generation (“2G”) cellular network and phone technology. Cellular phones using wireless web protocols to communicate over wireless cellular networks, however, have not been a completely suitable solution for mobile data exchange. For wireless access to the Internet using web phones, several problems in particular are encountered that limit the ability of a user to remain online for extended periods of time and thus encumber the ability of network users to obtain time-sensitive information from a network server in manners (such as polling) that are suitable for wireline based networks.

First, cell phones, because consumers wish for them to be small in size and lightweight, have fairly limited battery power. Online communication activity using wireless web and similar network applications consume a great deal of battery power. This inherently limits the amount of time a user can spend continuously online with a wireless web phone. Second, cellular customers typically pay for the use of the wireless network access based upon airtime. Web phone users would thus currently be required to use a substantial portion of their airtime if the need arose to monitor network information over an extended period of time (such as continuously over the course of an entire day).

Third, the usefulness of web enabled cellular phones are inherently limited by current hardware and ergonomic considerations. While fairly small palm-sized PDAs (such as those operating on the PalmOS or WindowsCE/PocketPC platforms) are available which have large color, touch-screen displays enabling users to view and surf through standard web content easily, customer preferences require that mobile telephones are much smaller by design. This small overall size dictates that web phones have substantially smaller displays (which in turn limit the amount and format of viewable content), and a rather limited battery life. Furthermore, users making network connections over web enabled wireless phones are often required to endure the arduous tasks of navigating and inputting words by typing on a telephone keypad. Thus, the design features prevalent in popular cellular phone designs currently make them poor choices as client devices for contemporary data networks.

Fourth, and possibly most importantly, as mentioned above, digital cellular web phones operate over currently available 2G cellular networks that support only relatively low bandwidths and thus restrict the scope of information available via web phones. While 2.5G and 3G wireless networks, both of the circuit and packet switched types such as TDMA, CDMA, GSM, GPRS, EDGE and UMTS, are being developed that will eventually address these network bandwidth problems, such future generation wireless voice/data networks will not address the problems inherent in the telephone handsets.

Finally, the incorporation of a cellular modem, or other wireless RF-based communication technologies, into PDAs has similarly not been successful in solving the above-described problems. The smaller an RF-enabled PDA gets, the worse communication reliability and PDA functionality becomes; the larger the PDA gets, the less consumers like the PDA because of loss of portability. As such, the introduction of a combination all-in-one cellular phone and PDA that will not meet consumer resistance is a significant problem. Consumers primarily want mobile phones that are very small and portable, yet still providing clear and reliable voice communication. While size is also a factor for PDA consumers, they primarily want sufficient data handling capabilities, simple input mechanisms, and large display capabilities. These differences in consumer preferences, especially the ergonomics factors, make current all-in-one PDA/mobile phones poor solutions to mobile networking needs. Additionally, combination PDA/phones, due to battery demands, limited service areas of RF-based networks and other restraints, still could not approach the real-time capabilities for continuous online connectivity provided by wire-line based network connections.

Currently, the mobile communication and networking market has not been able to provide a technology that works within the inherent limitations that are imposed by mobile users and current wireless networks while still providing the ability for users to receive time-sensitive alerts anytime and anywhere and to respond to those alerts with a minimum of effort. Therefore, there remains a need in the art for improved communication mechanisms that provide the benefits of continuously online networking while still maintaining the flexibility and mobility to provide critical time-sensitive information to a user wherever that user may be located and does not require the user to periodically poll the network to receive the time sensitive information. Further, there remains a need in the art for systems and methods that not only alert user regarding the occurrence of time sensitive events, but that also facilitates the act of responding to the event.

### SUMMARY OF THE INVENTION

Accordingly, the present invention is directed to a system and method that compensates for the above-described shortcomings of distributed computer networks such as the Internet in providing time-sensitive information to users wherever that user is located and over various communication mechanisms depending upon when the information becomes available.

It is therefore an object of the present invention to provide a system and method for providing time-sensitive notification alert signals from a computerized network to a network user such that whenever an event of interest occurs, a user can easily and quickly obtain information relating to that event wherever the user is located at a that time.

Additionally, it is an object of the present invention to provide a system and method that signals users regarding the availability of critical time-sensitive information relating to an event wherein the signals are se at over a plurality of mediums and across a plurality of platforms depending upon where the particular user is located at the time when the information becomes available.

It is also an object of the present invention to provide a system and method for mobile electronic communication that is flexible and approaches the reliability and functionality of continuous wire-line network connections without the need for polling of network servers.

Further, it is an object of the present invention to provide an intelligent system and method for electronic communication which enables time-sensitive communication with a mobile user and intelligently selects mechanisms for communicating with that user based upon the user's location and preferred communication mediums given that location. Additionally, it is an object of the invention that the mechanisms for communicating are platform-independent such that they can be performed using various offline and online signaling and communication protocols.

Finally, it is an object of the present invention to provide a system and method that allows mobile network users to receive alerts announcing the availability of time-sensitive information wherever the user is located, and assists users in responding directly to the alert and accessing the information with a minimum of difficulty.

Additional features and advantages of the invention will be set forth in the description that follows, and in part will be apparent from the description, or may be learned by practice of the invention. The objectives and other advantages of the invention will be realized and attained by the embodiments particularly pointed out in the written description and claims hereof as well as the appended drawings.

The above identified and other objects are achieved by the system and method for location independent and platform independent network signaling, signal interpreting and action initiating according to the present invention. The invention's method and system provide a mechanism whereby a user can receive signals on a time-sensitive basis regarding the occurrence of a triggering event. The signals are received on an electronic communication device over a network comprising various suitable electronic communication mediums and using various signaling mechanisms. Upon receiving the signal, the device interprets the signal and generates an alert for the user to initiate, or alternatively interprets the signal and automatically performs, an appropriate action or actions in response to the alert. In preferred embodiments of the invention, the network synchronizes, along with the sending of the signal to the user, a customized response path for the user to utilize so as to reduce the number of steps and thus simplify the steps required of the user's to actions in response to the event.

Electronic communication mediums suitable for the present invention can be of any infrastructure type including existing types such as standard telephone lines, wireless telephone systems, or dedicated network communication systems (such as wireline ISDN and T1 lines, or wireless computer networks). Signaling mechanisms utilizing such infrastructures comprise various types including online networking protocols, such as TCP/IP, and offline protocols such as, among others, those utilizing telephony caller identification technology (“caller ID”), short message services (“SMS”) technology, and telephony ring signal technology.

More particularly, preferred embodiments of the present invention pertain to a method and system for providing a signal to a network user's device wherein that signal is interpreted by the user's device to perform a predefined action. Said action can include generating an alert instructing the user that an event of interest has occurred, generating an alert that suggests that the user contact a host facility of the network for further information regarding a particular event, instructing the user or user's device to launch an application (on the device or externally), or providing input via event information embedded in the signal to an application running on the user's device.

In further preferred embodiments of the present invention, the synchronization of a customized response path further includes redirecting a user to a known address on the Internet (a “URL”) to information related to the underlying cause of the signal via a dynamic redirect pointer. In such embodiments, the dynamic redirect pointer is updated simultaneously with the sending of the signal regarding the event of interest to the user's device. In this manner, if the action in response to the signal comprises launching an Internet web browser and accessing a predefined URL, due to the dynamic pointer, a page request for the predefined URL, and thus the user's browser, is automatically redirected to customized information regarding the event that caused the alert.

Additionally, the present invention includes embodiments wherein the communication devices have signal receipt functionality embedded therein by dedicated signal receipt and interpretation software, or alternatively communication devices not having such software. In cases wherein there is no dedicated signal receipt and interpretation software, the present invention utilizes standard communication functionality present in devices of that type (such as caller ID or SMS technologies on a mobile phone) to receive and interpret the signal.

The invention will now be described in further detail with respect to particular embodiments thereof with reference to the figures. The following detailed description and figures are intended to be illustrative of particular applications of the inventive concepts and are in no way to be taken as limitative of the invention as claimed.

### BRIEF DESCRIPTION OF THE DRAWINGS

FIG. 1 is a schematic diagram illustrating a location-independent and platform-independent signaling, signal interpreting and action initiating system according to embodiments of the present invention.

FIG. 2 is a schematic diagram illustrating a location-independent and platform-independent signaling, signal interpreting and action initiating system according to embodiments of the present invention wherein a user is capable of receiving signals on various electronic devices, over various communication mediums, and using various signaling mechanisms.

FIG. 3 is a flow diagram depicting a method for location-independent and platform-independent signaling, signal interpreting and action initiating according to embodiments of the present invention.

FIG. 4 is a schematic diagram depicting the method and system according to preferred embodiments wherein the server synchronizes a customized response path concurrently with sending a signal to the client device.

FIGS. 5a and 5b are schematic diagrams depicting the method and system according to embodiments of the present invention wherein two communication devices, such as a wireless phone and personal digital assistant, are used in combination to receive and interpret a signal and resolve a single event.

FIGS. 6a, 6b and 6c are schematic diagrams depicting how a user can request an event trigger from an external third-party source and receive and interpret the event signal generated in response to the event trigger via the invention's system and method according to embodiments of the present invention.

### DESCRIPTION OF THE PREFERRED EMBODIMENTS

The herein-described system and method of the present invention enables users to receive essential, time-sensitive signals regarding events of interest that reach users on a real-time basis, and then enable the user and/or user's device to interpret those signals to take appropriate actions, such as launching or providing input to applications or going online, so as to react accordingly to the event. Signals according to the present invention reach users whether they're offline or online over various suitable communication mediums and using various signaling mechanisms. Additionally, preferred embodiments of the present invention further comprise, in addition to sending time-sensitive signals to the user, customizing streamlined response paths for the user such that suitable actions in response to the event can be made with a minimum of time and effort.

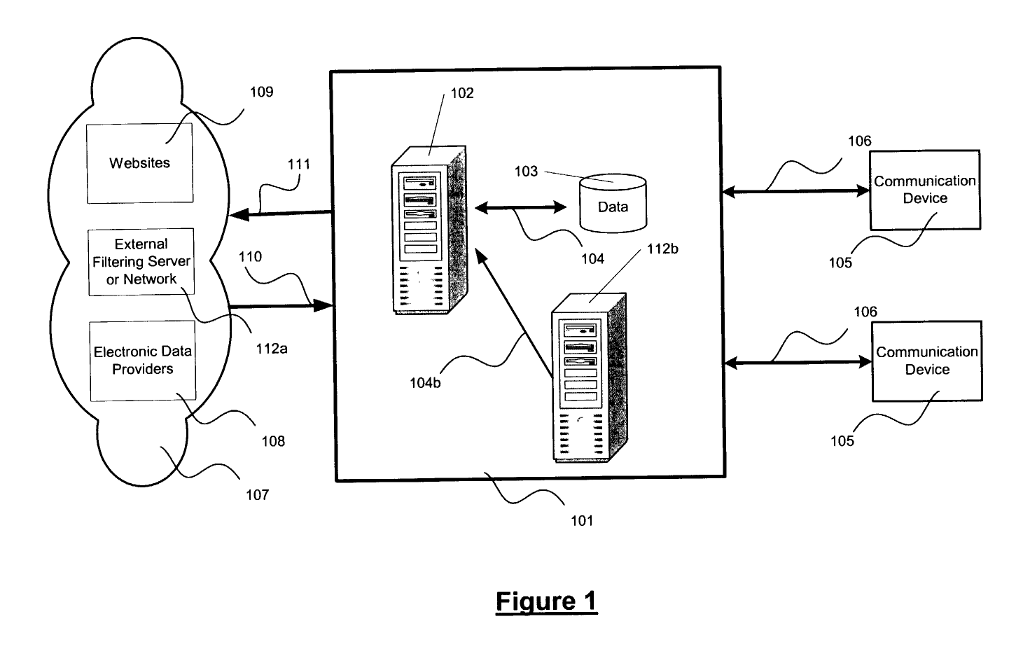

As depicted in FIG. 1, a system according to embodiments of the present invention comprises a central network 101 connected through various communication mediums 106 with electronic communication devices 105 belonging to a plurality of network users. A suitable network 101 preferably has a signaling server 102 in electronic communication 104 with an account database 103. The account database contains various information regarding each user of the network, including the number and type of client devices 105 each user utilizes to communicate with the network, the communication medium 106 and associated signaling mechanism(s) employed by each device 105, alert rules for determining when the server should send signals to a user, priority rules for determining how the server 102 should contact the users at any given time, and administrative and profile information relating to the account of each user.

The alert rules stored in the database 103 specify when users decide to receive real-time alerts. The user would identify an event that they would like to receive an immediate signal regarding (such as when a stock reaches a particular price, an email arrives from a particular sender, or the status of an airline flight changes), and enter an alert rule regarding the event directly into their user information while online with the network 101, or alternatively indirectly via a third-party network, online service, or portal. Any signal sent to a client device can generally be divided into two categories: those triggered by servers that internally filter event information and those triggered servers that externally filter event information.

External filtering servers 112a are located in information networks 107 that are external to and/or independent of the network 101 but are in electronic communication with network 101. These event servers 112a filter real-time information sources to determine when an event of interest to a particular user occurs. Whenever external filtering server 112a determines that an event of interest has occurred, it electronically transmits 110 a trigger regarding the availability of information pertinent to the event of interest to the network 101, and thereby instructs signaling server 102 to signal to the interested user substantially in real time. Suitable information sources that can be monitored by external filtering server 112a include electronic data feed providers 108, such as entities that continuously transmit or monitor financial ticker information to/for subscribers, and Internet websites 109.

Internal event filtering server 112b is located within network 101 and operates to send triggers 104b to signaling server 102 indicating the occurrence of an event of interest. In such cases, event filtering server 112b first makes a determination as to when an event of interest occurs. This determination made by internal filtering server 112b can occur in several circumstances, including those where the server 112b receives information from or monitors information on other servers within network 101 (such as a mail server or signaling server). For example, a first user could request that a signal be sent to him whenever an email from a particular second user arrives at his email account hosted by network 101, or the first and a second user (such as husband and wife or business partners, for example) could collectively request that whenever signals pertaining to certain types of events are sent to one user, the other user is signaled. In such cases event server 112b monitors appropriate data streams relating to these user-defined rules (such as by polling the mail server or receiving an indication from a signaling server that a signal relating to a particular type of event has occurred) to recognize the occurrence of the event of interest in substantially real-time.

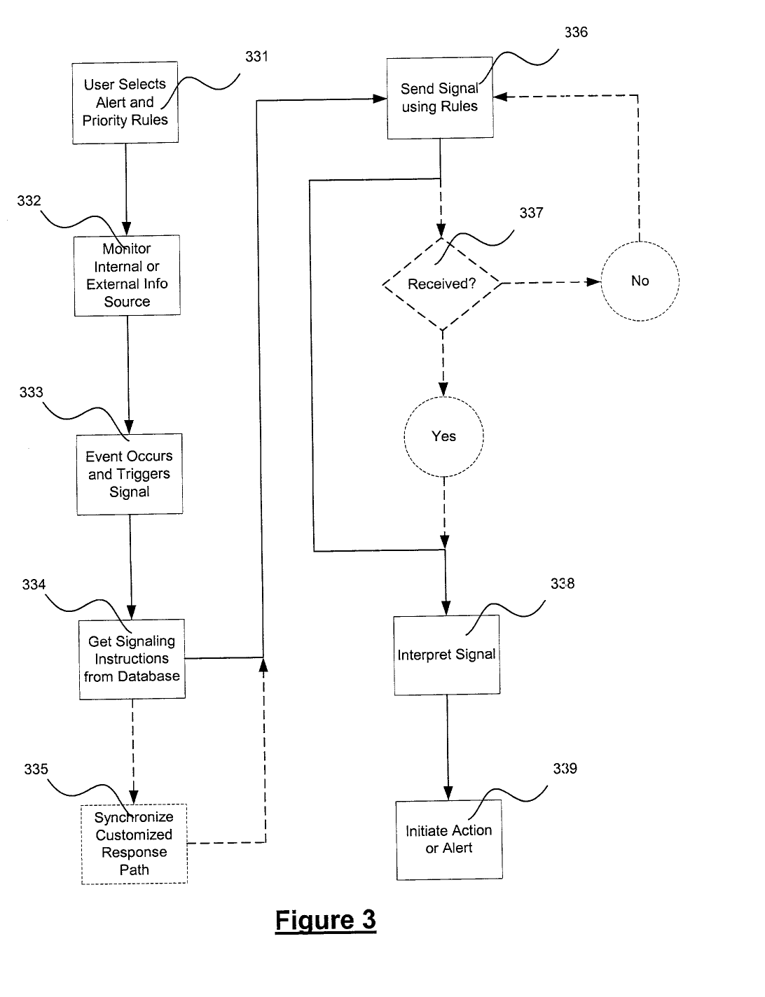

Internal event filtering server 112b could additionally be utilized to filter data electronically transmitted 110 from electronic systems located remote from network 101, such as external information networks 107. In this manner, bulk data (data sent intermittently in large quantities such as electronic catalog information by electronic data feed providers 108), stream data (data sent in constant streams such as stock ticker information), and data obtained by intelligent agents (such as by software adapted to “crawl” or access 111 third party websites 109 looking for information as is known in the art), could be sent to the network 101 wherein the internal server 112b filters the data to search for events of interest. Once such an event is identified, a trigger to that effect could be sent to the signaling server 102 to initiate the signaling process as described below with respect to FIG. 3.

Alternatively, the functions of the filtering server 112b and the signaling server 102 could optionally be performed by a single server.

As shown in FIG. 1, each device 105 is connected to the network 101 via a communication medium 106 through which the device 105 would receive any signals sent by the signaling server 102. Suitable communication mediums 106 employing wireline connections include standard telephone line infrastructure (for devices that utilize modems), and dedicated network lines (e.g., ISDN, T1, etc.). Similarly, wireless communication mediums include current cellular telephony networks, future telephony networks (e.g., 2.5 G and 3 G wireless networks), GPRS and other RF-based technologies. Additionally, as described above, communication mediums 106 of both the wireline and wireless types can use both online signaling mechanisms (such as TCP/IP, HTTP or other networking protocols) and offline signaling mechanisms. Offline signaling mechanisms suitable for embodiments of the present invention include, among others, SMS, telephony caller ID systems, and a proprietary telephony ring-and-delay technology owned and developed by the owners of the present application.

The proprietary ring-and-delay technology used in certain embodiments of the invention, referred to in industry as “morse signaling,” for offline signaling operates by controlling the occurrence and timing of the ring generation signals normally sent over telephony systems to cause a phone to ring. Offline signals generated using morse signaling are transmitted over the existing telephony (wireline or wireless) infrastructure and “tickle” the client device (such as a cellular phone or a modem equipped PC connected to a phone line) while offline to deliver real-time alerts. In this manner, a user can elect to receive signals that are interpreted by his device to generate alerts of an instant message, urgent email, chat session alert, previously requested online purchase opportunity, or other event of interest to an offline network device, or to launch, configure, or install various applications on the device when that offline device is linked to a telephone line (or cellular network) and is running appropriate software to monitor and interpret those controlled ring signals. As will be readily appreciated by one skilled in the art, this ring technology can be utilized to send signals to any offline computer, cellular telephone, personal digital assistant, or like client device that is connected to a telephony infrastructure and has the appropriate ring recognition and interpretation functionality embodied therein. The technology for signaling using these modified telephone ring signals, and for monitoring the telephone line and interpreting such signals is disclosed in four co-owned and co-pending U.S. patent applications, Ser. No. 08/925,075 filed Sep. 8, 1997, Ser. No. 09/550,587 filed Apr. 17, 2000, Ser. No. 09/599,430 filed Jun. 22, 2000, and Ser. No. 09/599,431 filed Jun. 22, 2000, the specifications of all four of which are herein incorporated by reference.

As discussed above, the database 103 can also contain priority rules as defined by each user such that the user can utilize more than one communication device 105 in conjunction with the network 101. The priority rules according to these preferred embodiments of the present invention thereby allows users of some combination of offline and online PCs and mobile devices (such as digital, PCS, or internet equipped cellular phones and PDAs), to receive real-time signals and alerts regarding time sensitive events wherever the users are located, whatever the users are doing, and upon the particular device that the users prefer to receive signals and alerts under those circumstances. In applying such priority rules, the signals can be simultaneously sent to multiple locations and devices, solely to a desired one of the user's devices, or in a selective and sequential manner to one or more separate devices in a series of devices as set forth below. Further, a signal can either be guaranteed (signal and await confirmation) or non-guaranteed (signal and forget).

It should be understood that in alternative embodiments of the invention, profile information for users, including e-commerce profile information (credit card numbers, billing and mailing addresses, etc.) can optionally be stored securely on the device instead of in database 103. In such embodiments, the user profile information can be electronically transferred to the network 101 or an external network 107 in response to an event of interest without the need to enter the information or to have the information stored permanently in database 103.

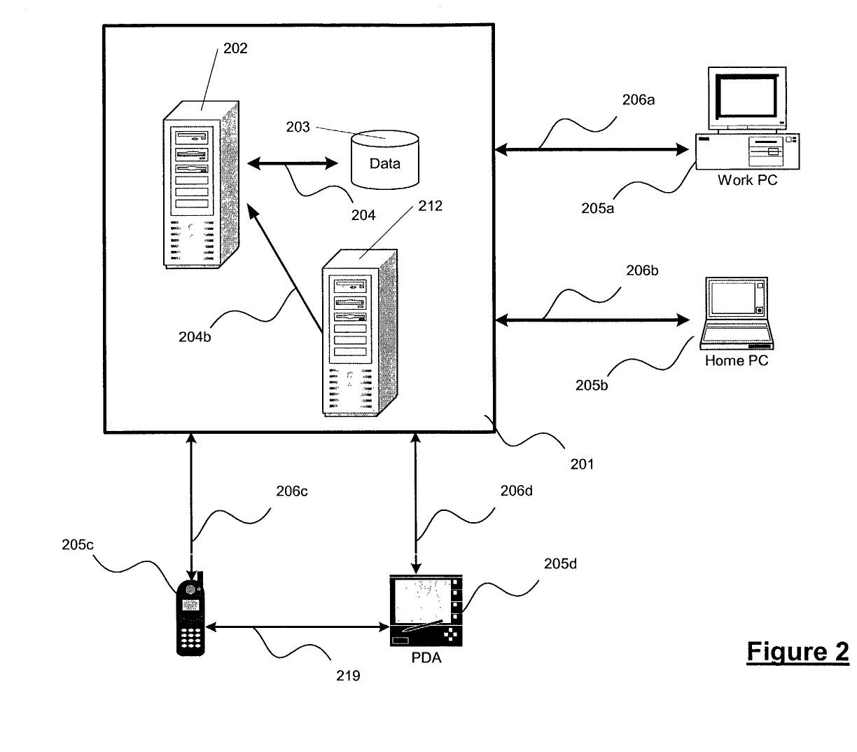

FIG. 2 depicts how a single network user can utilize priority rules to direct how alerts are selectively routed to a plurality of commonly-owned communication devices 205a-205d. The network 201 is substantially the same as the network as described with respect to FIG. 1 in that it contains a server 202 for receiving triggers and sending signals, an event filtering server 212, and an account database 203 containing device and rule information for the user. As shown in FIG. 2, this particular user has a work PC 205a that has a wireline connection 206a (such as an ISDN line) to the network 201 such that the work PC 205a is continuously online with the network via the Internet while the user is at work. The user also has a home PC 205b that is connected to the user's only home telephone line 206b (and thus the network 201) via a modem. Finally, the user has a PDA 205d and a cellular phone 205c.

Having the four communication devices 205a-205d, the user can specify a large assortment of priority rules. For example, the user could define a first priority rule whereby while the user is at work (i.e., whenever work PC 205a is powered on and thus online with the network) all event signals (unless otherwise specified for a particular event) should be sent over dedicated line 206a using TCP/IP to the work PC 205a. Various methods of keeping the server 202 apprised of the online status of a client device will be apparent to one skilled in the art. For example, the work PC 205a could send a message, or “ping,” the server 202 to indicate that it has gone online. An entry would then be made in a suitable location, such as database 203, to signify that the last known status of device 205a was “online.” Before sending a signal to device 205a, the server 202 would check the status of device 205a in the database 203 and determine if the device is online or offline according to its last recorded status. If the last information received indicated that the device was online, the server 202 would first try to send a guaranteed signal online using standard TCP/IP or other suitable online protocols. If no confirmation is received back then the status of the device in the database would be changed to offline and the priority rules would be applied accordingly to send the signal.

Similarly, the user could define a second priority rule (to be applied if the user is not at work) such that signals would be sent to the home PC 205b whenever the home PC is online via a dial-up connection. In this case, again the signaling mechanism would be of the online type using suitable protocols such as TCP/IP, and the determination as to whether home PC 205b is online could be made as described above with respect to work PC 205a.

A third priority rule could state that if the user is not at work or online with his home PC 205b, the network should notify him through his cell phone 205c using the cellular network connection 206c. The signaling mechanism used with respect to the phone 205c and cellular network could be the proprietary ring and delay technology, caller ID, or SMS if the device phone is offline, or a suitable wireless online internet protocol if the phone 205c is web-enabled and is online.

Finally, a fourth rule could state that if the cell phone is unavailable (such as when out of the service area or powered off) and neither the work PC 205a or home PC 205b is online, that the signal should be sent to the offline home PC 205b over telephone line 206b using the proprietary ring and delay technology.

Using the above four priority rules, the signaling server 202 would thereby progress through a series of potential client devices and signal the user on the preferred device using the preferred signaling mechanism for the particular time and type of event whenever a trigger is generated by internal event filtering server 212 or an external event filtering server (not shown in FIG. 2).

Alternatively to the above four rules, the same user could define a series of priority rules whereby signals are always sent to his cell phone 205c, and simultaneously sent to another device or other devices (such as home PC 205b or PDA 205d) as stipulated by several other rules. In this manner, a signal can be sent to a user's cellular phone over a wireless network connection 206c using caller ID technology, and simultaneously sent to the user's online PC at home using TCP/IP. Alternatively, one of the user's devices, such as the cellular phone, could be designated in the database 203 as the open “master” recipient of signals. In this manner, the cellular phone will receive all signals, such as via SMS, while it is powered on. At times when the cell phone 205c is turned off, all alerts will be sent to a secondary recipient such as the user's home PC 205b using either TCP/IP or ring and delay messaging depending upon whether the home PC 205b is online. In this manner, the alerting signal can be set to “follow the user” to ensure that the user receives alerts when they want and where they want.

Additionally, it should be understood that a particular user could optionally define an individual set of priority rules for each event of interest and its associated alert rule. In this manner, a special set of priority rules can be applied to a signal regarding a first event, such as an e-commerce opportunity, while a default set of priority rules can be applied to other events, such as a travel delay advisories, and so on.

FIG. 3 is a flow chart depicting the steps of a method according to embodiments of the present invention with optional steps and flow direction as used in preferred embodiments of the invention being shown in broken lines. Initially at step 331, a network user sets up his account with the network by selecting alert rules defining events to be alerted about and priority rules for determining how he should be notified. For each event that the user requested an alerting signal, the network or an external network monitors 332 the appropriate information source(s) so as to be apprised of the occurrence of the event 333 in substantially real-time. Immediately after it is determined that event has occurred a trigger is sent to the signaling server 333. Upon receiving the trigger, the signaling server accesses the alert and priority rules 334 to determine how (i.e., which device(s) and using what signaling mechanism(s)) to signal the user regarding the requested event alert. The server then sends the appropriate signal 336 to the user on the appropriate device(s) and with the appropriate signaling mechanisms as stipulated by the priority rules. Upon receiving the signal, the device interprets the signal 338. During the interpretation step, the device processes the signal to determine the proper action(s) to take, such as generating an audible/visible alert for the user, launching one or more particular applications on the device, or providing input using the signal to an application on the device. After the signal is interpreted, the appropriate action is then initiated by the user in response to an alert or automatically taken by the device 339.

In preferred embodiments of the invention, the server utilizes guaranteed signaling in that it waits for confirmation that the communication device has received 337 the signal. In such embodiments, the device would send a confirmation signal, using any of the above described signaling mechanisms, back to a confirmation server (not illustrated), such as the signaling server or another specified server, after receiving the signal to guarantee that the signal has been received and interpreted to generate the proper alert or to initiate the proper action. For example, once the receiving device confirms that the user has acknowledged an alert generated by the device (such as by “clearing” the alert via pressing a button on the device), the device would send a return confirmation signal to the server (such as an uncompleted call to a preset number wherein the device hangs up after a specified number of ring and delays or after sufficient time for the server to capture caller ID information, or via an SMS text message). In this manner, confirmation would be received by a server that the alert was received and/or that the user took action and the signaling server could cease efforts to notify the user. If a confirmation signal was not received, the server could continue to re-send the signals at step 336 as shown in the figure. If confirmation is received, then the confirmation server would cancel the process and instruct the signaling server to cease efforts for sending signals relating to that event until another trigger is received.

As described above with respect to FIG. 3, upon detecting an authentic signal, the user's device interprets the signal and then alerts the user by an appropriate alert signal, and/or performs any predefined functions associated with the signal at step 339. The alert signal to the user from the device can consist of text messages on a graphics display screen, graphical elements, sounds, or, in the case of cellular phones, ringing. Furthermore, multiple alert types for each device can be customized such that a unique alert type can correspond to a particular type of signal. In this manner, not only will the device alert the user that an event signal has arrived, but the particular form or type of the alert can also help the user to identify to what the alert pertains. For example, a different type of ring could be used as audible alerts on a web enabled cellular phone to help the user identify what type of events have occurred without the need to review the display on the phone.

In preferred embodiments, these alerts optionally include a button or a selectable hyperlink that will enable the customer to manually launch (or alternatively the device may automatically launch) applications associated with the alert and interpretation of the signal at step 339. While it will be apparent to one skilled in the art that various applications could beneficially be launched in response to a signal and its interpretation according to the present invention, by way of example, suitable applications include web browsers, live chat or instant messaging programs, application installation programs and Internet telephony programs.

In other preferred embodiments of the present invention, the server synchronizes with the sending of a signal in response to an event trigger the preparation of a customized response action path that facilitates and expedites the process of responding to an alert. In such embodiments as shown in FIG. 3, before sending the signal 336 to the user device, the server determines at 335 a suitable response path to the event. The response path would be selected so as to direct the user to information of interest regarding the triggering event when the user (or device) performs a predetermined action (such as simply acknowledging the alert signal on his device). For example, an alert having such a customized action path would enable a user to simply click on an alert button to launch his web browser and go directly to a pre-defined location on the Internet, or the browser could alternatively be automatically launched and directed to the predefined location or URL. Thus, once the user is online in response to the signal (in scenarios where the user wasn't online already), he can be automatically directed by the server, such as by customized hyperlinks on a webpage or dynamic URL redirection, to a set of information related to the event.

In more preferred embodiments of the present invention, the URL to which a web browser on the user's device automatically connects upon launching, known as the browser's homepage, can include a dynamic pointer that is appropriately modified by the signaling server at step 335. This dynamic pointer automatically redirects page requests for the user's homepage URL to another page on the internet that provides customized information about the cause of the alert and/or the information requested by the user.

In alternative more preferred embodiments of the present invention, the customized response path at step 335 would allow a user to simply click on an alert button to place a telephone voice call to a designated telephone number. When the user's call is connected in response to the signal and alert, the user is automatically greeted with a series of audible prompts (that were customized at step 335) relating to the specific event, a recording of information relating to the event, or connected to an operator who is familiar with the event. Thus, in this manner the user's task of taking action in response to a signal and alert, and thus the event of interest, would be much simplified.

Alternatively, the customized response path 335 could be implemented by using TCP/IP or SMS as the signaling mechanism whereby the signal itself contains customized response path information that could be interpreted by the device at step 338. For example, using SMS the signal sent at step 336 could contain text and/or character messages that direct the user and/or device to effect desired response actions. This functionality could be achieved by software present in the recipient mobile device (for example, a personal mobile telephone, personal digital assistant or similar device) that stores information regarding the relationship between text and/or character messages comprising the SMS signal and instructions that cause the device to automatically launch applications when certain SMS signals are received. One such example would be an SMS message specifying an Internet URL. The software would be programmed to identify SMS signals containing URLs in the interpretation step 338, and cause the device to commence an online session and access the URL specified in the SMS signal. It, however, should be appreciated that the URL may be the ultimate destination (containing information of interest relating to the event) or the URL may contain a dynamic pointer to the ultimate destination as described above.

Particular applications of the present invention will now be illustrated with respect to several examples.

### EXAMPLE 1

In embodiments of the present invention, signals can be received and interpreted using the inherent ability of mobile (wireless) devices to identify caller ID information of incoming yet uncompleted calls. This caller ID feature is achieved by software that is already resident in or loaded into a mobile (wireless) device (for example, a mobile telephone, personal digital assistant or similar device). The software is designed to recognize the caller ID information of incoming calls and to access a database of subjects (such as the names of callers) associated with different telephone numbers. In addition, the software can include pre-loaded alerts (which could consist of text, graphics, audio and/or video files that instruct the user to depress a hardware button that causes the device to automatically launch applications such as a browser and thus commence an online session and go to a specific Web page) for each of the subjects. When an incoming call signal is detected the software interprets the signal by obtaining the phone number of the incoming (yet unconnected) call using the ability of the device to identify the caller ID, and then comparing it with numbers in the number database. If a match occurs the software displays the alert associated with the number/subject on the display unit of the device and the user initiates the launching of any applications associated with the alert.

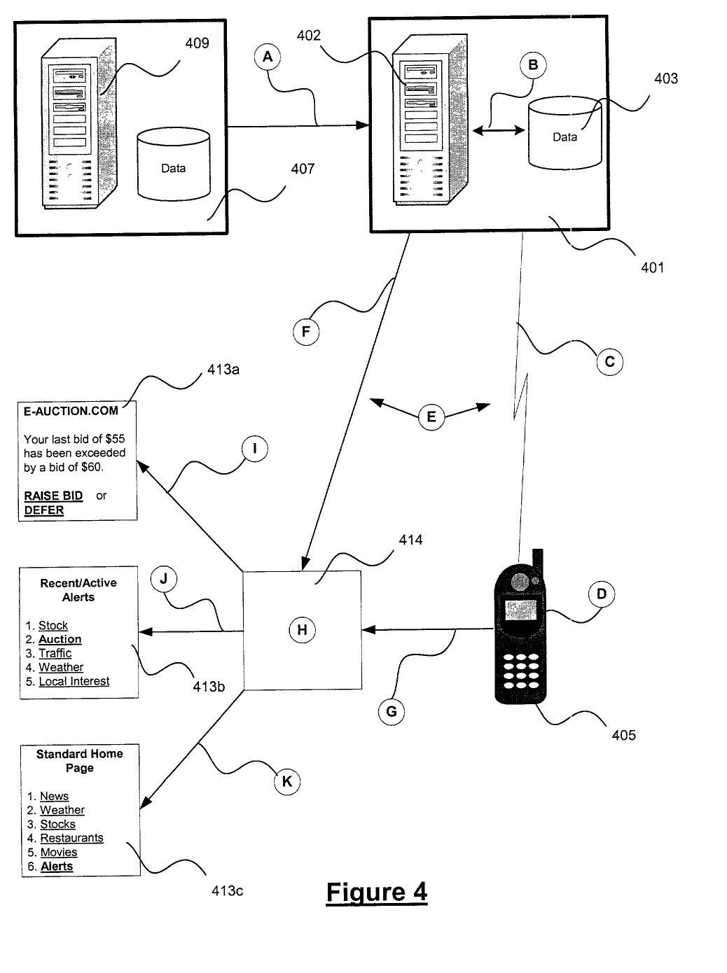

As illustrated in FIG. 4, this exemplary embodiment of the invention operates using a mobile device 405, such as a web-enabled cellular phone, that does not have specially designed signal reception and interpretation software loaded therein. Mobile device 405, however, is a digital cellular phone that comes standard with caller ID technology that enables it to identify the telephone number from which an incoming call has originated, as well as other identifying information. Typically, such phones having caller ID technology also typically allow the user to enter a database of phone numbers and associated names, such that when a call is detected that originated from one of the numbers stored in the database, the phone interprets the caller ID information and displays the name associated with the origination phone number. Therefore, the user of device 405 has programmed the database with several phone numbers (belonging to the network 401) and messages (in place of names), such as shown in Table 1 below.

TABLE 1

| Phone Number | Message |
|---|---|
| (202) 555-0001 | Stock Alert |
| (202) 555-0002 | PDA Alert |
| (202) 555-0003 | E-Commerce Alert |
| (202) 555-0004 | Airline Flight Delay Alert |

Therefore, whenever the information filtered by external source 407 identifies a change in the winning bid price of an online auction (the event of interest), an external filtering server will trigger network signaling server 402 (after determining the appropriate rules) to initiate a phone call to the user's mobile phone 405 from phone number (202) 555-0003, and the phone 405 would ring and display “E-Commerce Alert.” This would notify the user to go online, preferably using the dynamic hyperlinking mechanism described above, to perform suitable action in response to the price change. Preferably, the user's mobile phone 405 is also web-enabled and is configured with the browser's homepage (startup page) set to an Internet URL having the dynamic hyperlink. (Alternatively, of course, the user could use other means to access the dynamic hyperlink URL.) In this manner, the user could upon receiving the alert simply start their phone's web browser to be automatically linked to the appropriate information that triggered the alert. The steps below discuss with particular reference to FIG. 4 how this embodiment without special signal receipt and interpretation software on the device (other than what is standard on certain cellular phone models) operates in practice.

A)—A third-party network 409 outside network 401 sends to the signaling server 402 an electronic trigger that an “event” (described within database 403 by appropriate alert rules) has occurred and indicates the final URL where the user should go to complete the transaction associated with the “event” (e.g., if a user requests an alert when a bid they placed on an item has been outbid, the URL could redirect the user to a customized fulfillment webpage 413a on which all information associated with the user's transaction is displayed as well as any information necessary to update the bid with a minimum of steps).

B)—The signaling server 402 accesses information in database 403 about contacting the user regarding to the event (e.g., what number(s) and device(s) are associated with user, which device(s) to notify and in what order, the appropriate signaling methodology based on the time sensitivity of alerts, the desired device(s), supported signaling protocols, etc.).

C)—As directed by the database 403, the server 402 uses industry standard caller ID to notify the user and send the signal to the users mobile device 405 (however, SMS and other like technologies embedded in the device 405 could alternatively be employed) by placing a call to the device 405 from phone number (202) 555-0003, letting the phone line ring once, and then hanging up, thus allowing enough time for the caller ID information to be transferred but not enough time for a the telephone call to be completed.

D)—Device 405 receives the signal, interprets the signal by extracting the phone number from the caller ID information and comparing it with entries in its phone database, and alerts the user by ringing and displaying “E-Commerce Alert” on its display screen (the device's local “phone book” database having been programmed to associate caller ID information (origination telephone numbers) with different alerts or alert categories as shown in Table 1), thus ensuring that the proper alert is flashed on the screen in real time when a call is received.

E)—The sending of the alert to the device (step C above) is synchronized with the concurrent instruction to a webserver 414 that any requests for a user-specific URL (e.g., the URL the device 405 automatically requests at startup) are to be automatically redirected to a webpage 413a crafted by network 401 (or alternatively webserver 409) and having customized response path information relating to the event (in this case as shown in the figure, that the user's previously made bid for an online auction has been outbid, and giving the user the ability to increase his bid).

F)—Any page request obtained by webserver 414 for the user-specific URL is redirected to the customized webpage 413a due to the synchronization instruction of step (E).

G)—If the user is not already online, the user reacts to the alert by depressing a button on the phone that launches the browser to connect to the Internet. (Alternatively, if the user is already online, the user could simply access a hyperlink or bookmark to go to the user-specific URL) The request for the user-specific URL is then automatically redirected by webserver 414, and the user is sent to the customized fulfillment page 413a.

H)—The fulfillment page 413a is received, and information regarding the event of interest that generated the signal and alert is displayed giving the user the opportunity to respond to the event in as desired and in an expedient manner.

### EXAMPLE 2

The dynamic redirection of URL requests to pages on the web serving as customized response paths could be accomplished in various manners. For example, the user discussed above in example 1 could alternatively be provided with the option to select (such as at the time of making an alert rule) three customized response paths. In all three cases, as described above with respect to example 1, the user is given an alert by his device 405, launches his web browser, and requests (automatically or manually) his user-specific URL. (Alternatively, the accessing of the user specific URL could be seamless with the device automatically launching the web browser and requesting the URL in response to the signal). In each case, however, a different page could be loaded by the same URL request by the operation of the synchronization and redirection mechanisms. As described by example 1, in the first response path, the user could access his user-specific URL over the Internet and be automatically redirected (I) by webserver 414 to a customized fulfillment webpage 413a. As shown in FIG. 4, this customized fulfillment webpage 413a could contain information identifying the nature of the response (in this case, that the user has been outbid on a particular online auction and the current high bid) and one or more actions for the user to take (defer to the high bid, or raise your bid the minimum increment) via a hyperlink, button click, or other suitable means. In this manner, the automatic URL redirection to customized fulfillment webpage 413a would enable the user to respond to the action in a single step after launching the web browser.

Alternatively, the user-specific URL could be automatically redirected (J) by webserver 414 to an itemized event webpage 413b. As shown in FIG. 4, the itemized event webpage 413b could contain a list of hyperlinks, with a hyperlink representing each type of event of interest that the user has defined alert rules in the database 403. Thus, the user in example 1 alternatively could be presented with event webpage 413b upon launching his browser. He would then manually select the appropriate hyperlink (“Auction” in this case), which optionally could be set off by bold typeface or other suitable means, that in turn navigates him to an appropriate customized response path to the event (such as a redirection to customized fulfillment webpage 413a as described above).

Finally, the user-specific URL request issued upon launching the user's browser could load a standard home webpage 413c belonging to the user. Referring to FIG. 4, the standard home webpage 413c could contain a hyperlink (designated “Alerts” in the figure) that would, when properly synchronized by server 402, direct the user to means for initiating response actions, such as an itemized event webpage 413b or customized fulfillment webpage 413a.

### EXAMPLE 3

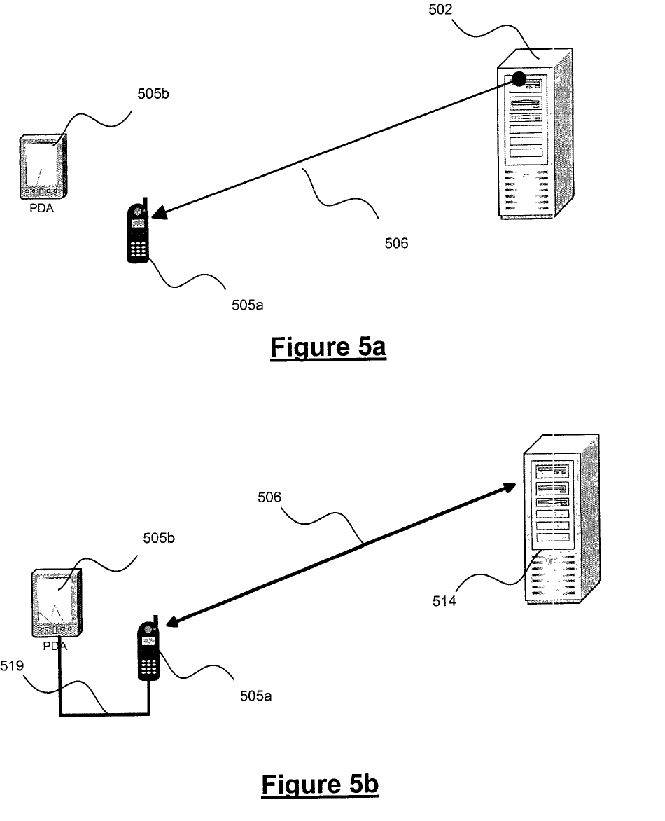

According to the present invention, the user may request to receive alerts on a device other than the particular device ultimately used to perform the response action to resolve the underlying event that triggered the signal. In embodiments such as this (depicted by FIG. 5), an offline signal would be sent to a first device 505a that contains signal receipt and interpretation functionality, such as the user's cellular phone, that would display an alert indicating an action needs to be performed on a second device 505b. For example, the cellular phone could receive a signal and display a message such as “PDA Alert,” thus instructing the user to connect to the network 101 with a PDA. At this point, the user would either use a communications cable to connect the PDA to the mobile phone to gain modem/telephony access and initiate a network/Internet connection (via an ISP) or perhaps just press a button to connect to a network/Internet in the case where the PDA has its own wired or wireless modem/telephony capabilities. In either case, the PDA would recognize the cable connection and automatically (or alternatively upon the press of a button) initiate a communications sequence in the manners as described above with the server using either the modem/telephony capabilities of the mobile phone or the PDA itself. Using the now online PDA, the user then can access webserver 514 to determine additional details of the alert (such as via a dynamic hyperlink), link to a transaction, or make an application connection as appropriate to respond to the alert. Examples of such a tandem device system is depicted in FIGS. 5a and 5b.

In FIG. 5a, a signal indicating the occurrence of an event is sent over the cellular telephony network 506 from the signaling server 502 to a first device 505a, the user's mobile phone. The signaling mechanism defined by the user is SMS, and the SMS signal contains an alphanumeric text message that reads “PDA Web Alert.” Device 505a receives the SMS signal, interprets the text message, and alerts the user by ringing and displaying the alert text using the mobile phone's standard text paging functionality.

When able, the user then initiates (shown in FIG. 5b) the proper response action by attaching a second device 505b, his PDA (if the mobile phone does not have web browsing or other online capabilities), to the cell phone with a cable 519. Cable 519 then enables the PDA to use the cell phone as a wireless modem/telephony device to connect to a webserver 514 (such as via a third party ISP) to gain Internet access. Once the PDA is online, the user can use its web browsing software to act in response to the event as in any of the manners described above.

It should be readily appreciated that many alterations could be made to the above-described scenario. Alternatively, in FIG. 5b instead of using cable 519 and the cell phone to connect to server 502, the PDA could use its own wireline or wireless modem, if available, to gain Internet access after receiving the mobile phone alert. Additionally, in FIG. 5a the signal could be automatically transferred from the phone to the PDA using Bluetooth or similar wireless technologies such that the alert is displayed, or a response action is automatically initiated, by the PDA. Furthermore, second device 505b could be any type of networking device suitable for the user to contact server 519, such as the user's home PC, a second mobile phone that is web-enabled, etc.

### EXAMPLE 4

The intelligent offline signaling capabilities offered by the present invention can also be used to extend the battery life of wireless communication devices, such as web-enabled cellular phones. In such applications, offline signals are sent from a signaling server (or another user via the signaling server) to a device, where the device is running in a power saving mode. The received signals are then interpreted by the device to “wake up” (power-up) and launch applications which are power intensive (and thus which are undesirable to leave running continuously). For example, a digital phone can be running signal reception software according to the present invention and be programmed by the user to operate in power save mode and to stay in that mode until the user otherwise specifies or until one or more particular signals representing events of interest are received. These signals can represent, merely by way of example, incoming calls from specified phone numbers, or special ticker information relating to a specific stock. During this power save mode, the specific pre-selected signals sent via an appropriate offline signaling mechanism (such as the proprietary ring-and-delay technology) are received and interpreted by the device as a wake up instruction that causes the device to launch the proper applications for use with the signal (such as a web browser application or cellular phone capability), while all other signals would not cause any action on the device (e.g., calls from other phone numbers would be sent directly to voicemail, and other stock ticker information signals that would normally be interpreted to generate an alert would be ignored).

### EXAMPLE 5

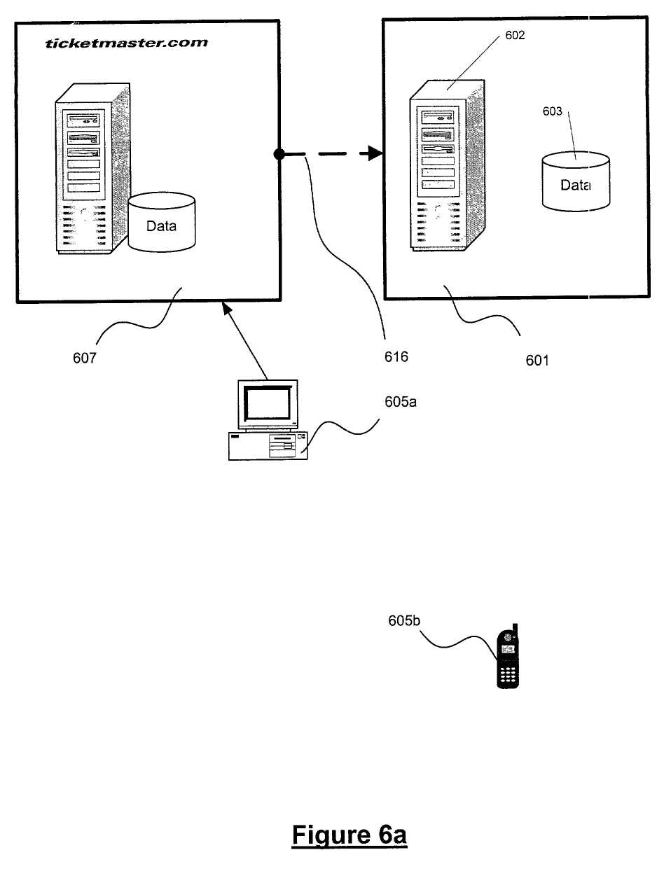

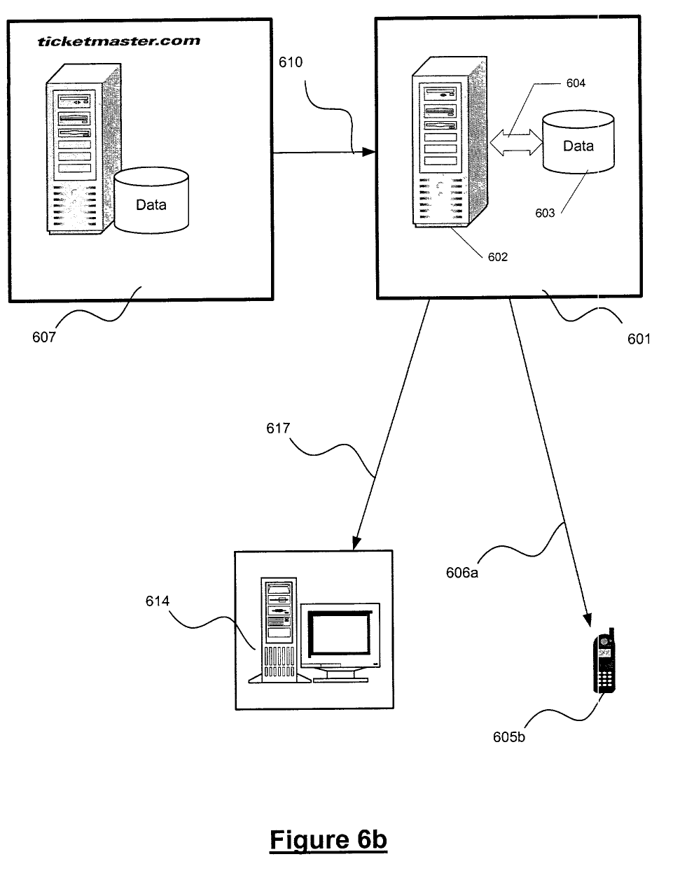

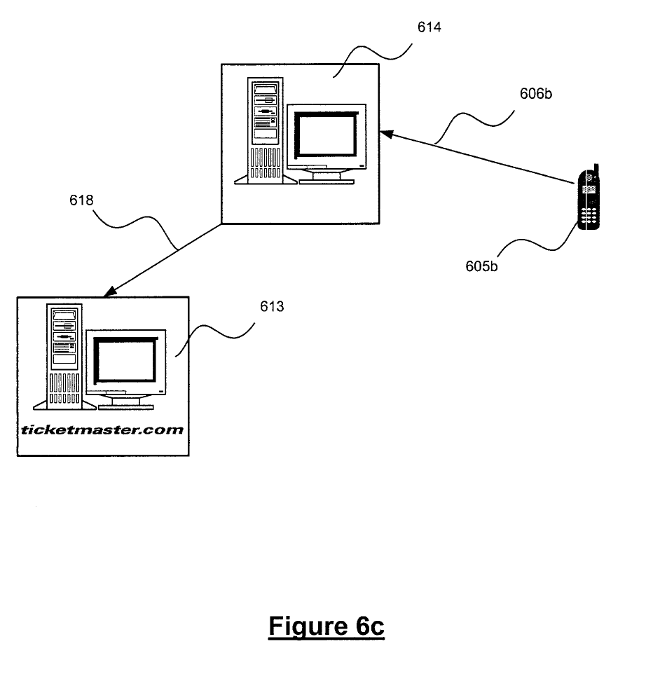

Referring to FIGS. 6a, 6b, and 6c, there is depicted a transaction between a user and a third party website 607 wherein the user desires to receive a real-time signal and alert via network 601 on his web-enabled mobile phone 605b when opening day baseball tickets go on sale on the website 607. In FIG. 6a, the user configures his alert rules by going online with his work PC 605a and accessing 615 the third party website 607 directly to inquire about the desired tickets. Once informed that the tickets are not yet available, the user selects the service (provided by the website 607 in conjunction with the network 601) to get a real-time event signal and alert when the tickets become available. The third party website 607 then contacts 616 the network 601 to inform the NETWORK 601 of the event signal and alert request, and an appropriate alert rule is recorded in database 603.

FIG. 6b represents the period in time just after the baseball tickets are made available online. Third party website 607 (having been acting as the filtering server) electronically transmits a trigger regarding the occurrence of the event of interest (the availability of tickets) to signaling server 602. The server 602 then accesses 604 the appropriate alert and priority rules for the event and user, and sends 606a an electronic signal over the cellular telephony infrastructure to the user's mobile phone 605b using the appropriate offline or online signaling mechanism as defined by the priority rules. Simultaneously with the sending of the signal, the server sends a synchronization signal 617 to alert webserver 614 to redirect the user's home wireless webpage URL to an appropriate customized response webpage (such as a customized fulfillment webpage requiring only for the user to enter the desired number of tickets to conclude the transaction) provided by the third party website 607.

FIG. 6c represents the period in time just after the alert generating signal 606a and synchronization signal 617 are sent. The user's phone 605b receives the signal 606a and interprets the signal 606 as an instruction to provide an audible prompt to the user and automatically connect 606b to the Internet using the wireless web capabilities of his mobile phone 605b. Alert webserver 614 receives the phone browser's request for the user-specific URL and automatically redirects 618 the page request to a customized fulfillment page hosted on an e-commerce webserver 613 operated by the third party website 607. In this manner, the user is seamlessly connected to a page that allows him to finalize a ticket purchase with a minimum of time and effort (such as entering the number of desired tickets and clicking a button to buy).

### EXAMPLE 6

The intelligent signal receipt and interpretation capabilities provided by mobile devices having software according to the present invention installed therein can also be used to configure or install applications on the devices. As will be readily appreciated by one skilled in the art, the installation of software on contemporary mobile communication devices, and, in particular, wireless phones, is a difficult task. A mobile device having signal receipt and interpretation software according to the present invention could obtain instructions to configure or install applications remotely by commencing an online session. In this manner, software version or functionality upgrades can be pushed onto many wireless devices without the need to individually reconfigure each device.

For example, a user could receive a signal on his wireless device which automatically launches his web browser and directs the browser to a page having signaling software upgrades available for download. Preferably, these signals could be sent at times of low network traffic so as to minimize the connection time needed to install the new software.

Similarly, a user could download various types of information from the network to his mobile device to be used in conjunction with already installed applications. For example, the user could download appointment information from an online calendar service for use with a date book application on the device, or download information pertaining to alert and priority rules that have been set with the network so as to configure the device to display appropriate alerts (such as special rings) whenever certain signals are received.

### EXAMPLE 7

In other preferred embodiments of the present invention, signals could not only be received and interpreted by an electronic communication device but also triggered by such a device. In such embodiments, a first device sends a trigger to the signaling server in the network. Upon receiving such a device generated trigger, the signaling server then considers the appropriate alert and priority rules and sends a signal to one or more other user devices. In this manner, one or more users can operate in tandem with respect to various events of interest.

As will be readily appreciated by one skilled in the art, the ability to trigger with a first device the sending of a signal to a second device can in practice be utilized for many useful purposes. The first (trigger sending) device in essence therefore could be utilized as a remote control of the second (signal receiving and interpreting) device when the signals are interpreted to launch particular applications or configure running applications on the second device. For instance, the above device-to-device signaling could advantageously be employed to monitor and control a “smart house” wherein a home PC is used to operate various house appliances and functions. (Alternatively, direct communication with various “smart appliances” could be employed). If a user receives an alert on his mobile phone that his flight home has been delayed by two hours, he could initiate a trigger that would cause the network to signal his home PC to that effect. The PC then interprets the signal as a request to alter various preset “smart home” functions, such as to delay the turning on of the oven by a two hours to prevent burning of dinner, or to turn the air conditioning on such that the house is not too hot to sleep when the user finally arrives. Alternatively, signals regarding the status of the smart house could be triggered by the home PC and sent to the user's mobile phone.

### EXAMPLE 8

The United States Federal Communications Commission (FCC) has mandated certain requirements regarding the ability of U.S. wireless telephone carriers to pinpoint the location of callers to 911 emergency services within a radius of 125 meters 67% of the time by a deadline of Oct. 1, 2000 (the “E911 Mandate”). The E911 Mandate deadlines are spurring the development of numerous positioning determining (“PDE”) technologies for incorporation into and use with future mobile phones. As will be readily appreciated by one skilled in the art, mobile phones having signal receipt and interpretation software according to the present invention installed therein could similarly provide PDE capabilities whenever a confirmation signal is sent by the mobile phone in conjunction with guaranteed signaling.

Additionally, however, the PDE capabilities could be utilized in conjunction with the event signaling aspects of the present invention to support new mobile commerce applications, like “m-coupons” that can be sent to users based on their location and their buying preferences and behavior. in this manner, time sensitive and geographically targeted advertisement, commerce opportunity, or coupon is sent to the user that can be fulfilled in any of the manners described above.

It will be appreciated by one skilled in the art that online sessions over telephony networks with network servers results in at least the following two limitations for the user: (1) the user incurs telephone line charges and, in the case of cellular modems, air time line charges, for the entire duration of the call; and (2) the availability of the telephone line for other uses, such as making standard voice telephone calls, is compromised. These two above-cited limitations become problematic when the user does not have a dedicated computer phone line and requires his or her PC to be online with a central network for an extended period of time. Therefore, for example, if a network user is awaiting the receipt of an urgent electronic mail message, the user must elect either to stay online with the central system until the mail message is received or either continually log on and log off the central system to check and see if the message has arrived (this is assuming that the network user does not wish to occupy the phone line with the computer for an extended period of time). Due to the above-described inherent limitations of such connections established over a phone line, it will be readily appreciated by one skilled in the art that using ring-and-delay signaling, SMS, and caller ID technology will permit signals and alerts according to the present invention to be made on a real-time basis without tying up a phone line and incurring toll and air-time charges.

The foregoing description, examples and figures pertain merely to preferred embodiments that are intended to illustrate the principles of the present invention. Those skilled in the art will be able to devise numerous arrangements, which, although not explicitly depicted or described herein, nevertheless, employ principles that are within the spirit and scope of the invention.

What is claimed is:

1. A location independent and platform independent method for a user receiving a signal regarding the occurrence of an event of interest comprising:
before the occurrence of said event of interest;
defining rules regarding how said signal is transmitted to said user depending upon where the user is located and what the user is doing when said event of interest occurs;
filtering information from an information source to identify the occurrence of the external event;
after the occurrence of said event of interest;
sending a signal to said user according to said rules, and where said user is located and what said user is doing when said event of interest occurs; and
interpreting said signal to enable said user to respond to said occurrence of said event in substantially real-time.

2. The method according to claim 1, wherein said signal is sent over various electronic communication mediums and using various signaling mechanisms as stipulated by said rules.

3. The method according to claim 2, wherein said rules comprise priority rules, said priority rules dictating circumstances regarding how to send said signal depending upon where said user is located and what said user is doing, said priority rules also dictating a particular electronic device that said user prefers to receive signals and alerts under those circumstances; and wherein said sending of said signal is performed only after determining an appropriate priority rule from a ranked a series of said priority rules.

4. The method according to claim 1, wherein said user receives said signal with an electronic device, and wherein said electronic device interprets said signal and is selected from the group consisting of a personal computer, a network terminal, a web-enabled cellular phone, and a personal digital assistant.

5. The method according to claim 1, further comprising: after said user is alerted by said signal, performing at least one action in response to the occurrence of said event.

6. The method according to claim 5, wherein simultaneously with sending said signal to said user, a customized response path for said user is generated so as to simplify the performing of said at least one action in response to the occurrence of said event.

7. The method according to claim 6, wherein said synchronizing of said customized response path includes preparing a telephone operator to receive a telephone call from said user, wherein said action in response to the alerting comprises said user placing said telephone call, and wherein said user is instructed by said synchronization to provide customized information regarding said event of interest to said user.

8. The method according to claim 6, wherein said synchronizing of said customized response path includes instructing a webserver to redirect requests for a predefined web address to a second web address containing customized information relating said user and said event of interest.

9. The method according to claim 8, wherein said predefined web address is a URL specific to and known by said user, and wherein said at least one action in response to said alerting of said event comprises said user requesting said URL from said webserver.

10. The method according to claim 4, further comprising: performing after said signal is interpreted at least one action in response to the occurrence of said event.

11. The method according to claim 10, wherein said at least one action is performed with said electronic device and is of a type selected from the group consisting of generating an alert perceivable by said user, establishing an automated connection over the Internet, the launching of one or more applications, configuring one or more applications, installing one or more applications, sending a confirmation signal, and making a telephone call.

12. The method according to claim 11, wherein said alert comprises directing said user to automatically connect to the Internet by performing a prompted action, said prompted action being selected from the group consisting of clicking on a button, entering a PIN number, and depressing a key.

13. The method according to claim 10, wherein said signal is received using said electronic device, and at least on of said actions is performed by said user utilizing a second electronic device.

14. The method according to claim 4, wherein said electronic device sends a second signal over said communication medium to represent that said device is online.

15. The method according to claim 4, wherein said electronic device sends a confirmation signal over said communication medium to represent that said signal has been received and interpreted.

16. The method according to claim 15, wherein said communication medium is a wireless communication network and an origination location of said confirmation signal is further obtained to determine a last-known location of said user.

17. The method according to claim 16, wherein said last-known location of said user is recorded in said rules, and wherein said event of interest is geographically related to said last-known location.

18. The method according to claim 4, wherein said communication medium comprise a telephony infrastructure, and wherein said notification signal comprises a telephone call placed from a predefined telephone number to said device over said telephony infrastructure.

19. The method according to claim 2, wherein said notification signaling mechanism is comprises a type selected from the group consisting of a short messaging services, caller identification, morse signaling, and polling.

20. The method according to claim 4, wherein said device is a mobile telephone, wherein said mobile telephone has functionality to identify caller identification information for incoming uncompleted phone calls, and wherein one or more origination numbers or other caller identification information are associated on said device with an alert indicating a manual action to performed by said user upon being alerted.

21. The method according to claim 4, wherein said signal is interpreted by said device as a wake up signal to said device when said device is operating in a power saving mode.

22. The method according to claim 4, wherein associated with said device is a second device for which said signal is intended, said second device being offline and not having available offline signal receipt functionality, and wherein said method further comprises sending said signal to said device, said signal being interpreted by said device to instruct said second device to connect to a remote network for additional information regarding the occurrence of said event of interest.

23. The method according to claim 4, wherein said device does not have special notification software installed therein.

24. The method according to claim 1, wherein said user receives said signal with a first electronic communication device, and wherein said sending of said signal is triggered by a second device.

25. A system for sending signals in substantially real-time after occurrences of events of interest comprising a network and one or more electronic communication devices connected over one or more communication mediums, said network comprising:
an information source filter; said filter adapted to determine the occurrence of the events of interest;
a data store for recording a series of rules that define how to send signals regarding the occurrence of the event of interest when said event occurs; and
a communication medium through which a signal indicating the occurrence of said event of interest can be sent to said electronic communication device after the occurrence; and each of said electronic communication devices comprising:
a receiver adapted to receive said signal over said communication mediums; and
wherein said electronic communication devices are adapted to interpret said received signal so as to initiate one or more appropriate actions in response to the occurrence of said event of interest.

26. The system according to claim 25 further comprising a server; said server being adapted to select and use an appropriate signaling mechanism and communication medium, and said server being adapted to send said signal to said communication devices depending upon said series of rules.

27. The system according to claim 25, wherein said devices have software that provides logic for receiving and interpreting said signals from said network.

28. The system according to claim 27, wherein said electronic communication devices comprise mobile telephones and said software comprises signal receipt and interpretation technology selected from the group consisting of caller identification technology, short message services technology, polling technology, and morse signaling technology.

29. The system according to claim 26, wherein said filter is located remotely from said server and in electronic communication with said server such that said filter electronically transmits a trigger to said server in substantially real time whenever one of said events of interest occur.

30. The system according to claim 25 wherein said data store is a relational database, and said relational database contains said rules to identify events of interest for a plurality of users.

31. An electronic communication device for receiving signals from a network regarding an occurrence of an event of interest, said device comprising:
software embodying instructions for receiving signals from said network and interpreting said signals to perform an action, said action being selected from the group consisting of playing an audible alert, displaying a visible alert, launching a device application, configuring a device application, providing input to a device application, and installing a device application, wherein said action facilitates the task of responding to the event.

32. The device according to claim 31, wherein said software is adapted to receive and interpret signals comprising short message services messages containing Internet addresses, said short message services messages instructing a user of said device to access the Internet address in order to obtain customized information that facilitates responding to the event of interest.

33. The device according to claim 32, wherein said software is further adapted to extract said Internet addresses from said short message services message and initiate an online session with said device, said online session automatically accessing said extracted addresses such that said user is provided with customized information that facilitates the task of responding to the event of interest.

34. The device according to claim 31, wherein said software is adapted to receive signals comprising uncompleted phone calls having caller identification information contained therein and to interpret those signals using a local database that associates known alert phone numbers with alert messages, said software causing said device to display said associated alert message if said caller identification information matches said alert phone numbers wherein said displaying of said alert message indicates the availability of customized information regarding the occurrence of an event of interest by accessing a predefined Internet location.

35. The device according to claim 34, wherein said device further comprises means for accessing the Internet, and wherein said means for accessing the Internet automatically accesses said predefined Internet location upon connecting to the Internet.

36. The device according to claim 35, wherein said device comprises a web enabled mobile telephone and said means for accessing the Internet comprises web browsing software on said mobile telephone, and wherein said startup URL for said web browsing software is configured to be said predefined Internet location such that said browser automatically accesses customized information relating to said event of interest upon being launched.

37. The device according to claim 31, wherein said software is adapted to receive signals generated using signaling mechanisms of types selected from the group consisting of caller identification technology, short message services technology, polling technology, and morse signaling technology.

38. The device according to claim 31, wherein said software is adapted to store user profile information on said device, said profile information being usable by said device in performing said action.
